(19) United States
(12) Patent Application Publication
(10) Pub. No.: US 2004/0172520 A1
(43) Pub. Date: Sep. 2, 2004

(54) Methods and apparatus for visually creating complex expressions that inform a rules-based system of clinical decision support

(76) Inventors: Michael Smit, Madison, WI (US); Khiang Seow, Madison, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/666,862

(22) Filed: Sep. 19, 2003

Related U.S. Application Data
(60) Provisional application No. 60/411,914, filed on Sep. 19, 2002.

(51) Int. Cl. G06F 7/38

(52) U.S. Cl. 712/223

(57) ABSTRACT

A method of constructing a Boolean expression in a clinical setting, including identifying at least a first and a second data assertion to add to the Boolean expression, adding at least one Boolean logical operator to the Boolean expression, determining an order of evaluation for the first and second data assertions, and visually depicting the first and second data assertions and the Boolean logical operator in a hierarchal display.

### CROSS-REFERENCE TO RELATED APPLICATION

This application claims benefit of U.S. Provisional Application Serial No. 60/411,914, entitled “Methods and Apparatus for Visually Creating Complex Expressions that Inform a Rules-Based System of Clinical Decision Support” filed Sep. 19, 2002 (attorney docket no. 29794/38804), the disclosure of which is hereby expressly incorporated herein by reference.

### TECHNICAL FIELD

The present patent relates generally to patient care and health record management, and more particularly, the present patent relates to methods and apparatus for constructing complex Boolean expressions that inform a clinical decision support (CDS) mechanism, such as that employed by a rules engine within an Electronic Medical Record (EMR) software system.

### BACKGROUND

Much of medicine is algorithmic. A medical professional typically follows a sequence of steps to diagnose a patient's ailment and determine an appropriate treatment. To support the physician or other medical specialist in making patient care decisions, some modern EMR systems transform these algorithms into a series of rules that, in effect, add intelligence to the EMR system. Those skilled in the art refer to this added intelligence as rules-based decision support.

In general, decision support features within an EMR system provide timely alerts, proactive guidance, and financial suggestions, all of which serve to improve patient care and reduce healthcare costs. For example, when a physician uses the EMR system to order or prescribe a medication for a particular patient, the decision support features may display an alert that informs the physician about potential drug-drug interactions or drug-allergy concerns that are specific to that patient.

In a rules-based system, a rule instructs the EMR system how to behave at certain key points within the clinical decision flow. The decision support mechanism determines what action to take by evaluating a set of data items at the decision point and by applying the logic contained within any associated rule expressions.

For the purposes of this discussion, decision support rules may be categorized as either objective or subjective. Objective rules are based on industry-established facts regarding the treatment of a particular ailment. Objective rules can be developed from, for example, the package insert information of drug manufacturers and from peer reviewed and published journal articles. Subjective rules are based on expert opinions, observations and experience. Subjective rules can be developed from, for example, the experience of a number of medical professionals who are involved in clinical practice, research or clinical trials.

Both objective and subjective rules can be quite complex and contain many expressions that the CDS mechanism must evaluate. Boolean expressions, such as those found in many CDS rules, often combine arithmetic, comparison and logical operators, which further adds to the rule complexity. Yet, most decision support mechanisms do not support robust methods for creating and editing these rules. For example, a clinician may want to create a subjective rule that instructs the EMR system to alert the user when any drug classified as a beta blocker is prescribed to a patient diagnosed with any one of several forms of asthma. As those skilled in the art would understand, this rule might contain a conditional statement with a complex Boolean expression similar to the following (shown here written in the Arden syntax):

if Meds contains PHARM CLASS Beta Blockers and

(Dx contains 493.00-EXT ASTHMA W/O STAT ASTHMA or

Dx contains 493.10-INSTRINSIC ASTHMA or

Dx contains 493.20-CHR OBST ASTHMA W/COPD W/O STAT ASTHMA or

Dx contains 493.21-CHR OBST ASTHMA W/COPT W/O STAT ASTHMA or

Dx contains 493.9-ASTHMA NOS or

Dx contains 493.90-ASTHMA NOS W/O STAT ASTHMA)

then conclude true

else conclude false

endif;;

There are few, if any, tools to assist clinicians or other computer users with the creation of these complex expressions. Creating and editing such statements often requires a detailed technical understanding of a specialized rule syntax, including knowledge about the order of precedence within the rule expression and the ability to derive meaning from a series of expressions enclosed within nested parentheses. This understanding often goes beyond the knowledge of the clinicians or medical specialists, who are otherwise best equipped to author CDS rules. Because of this limitation, rule editing is often relegated to database administrators or other computer specialists who are knowledgeable about rule syntax, but who may be wholly ignorant of clinical practices and medical algorithms. This is certainly problematic. As those skilled in the art would understand, decision support mechanisms within EMR systems are only as intelligent as their underlying rules.

Several existing solutions, whether they employ a graphical user interface (GUI) or text-based screen entry, allow the user to create the rule logic statement by typing it, as one would type a sentence. This method is prone to typographical errors and often elicits poorly formed (incorrectly nested) logic structures.

One of the existing solutions that employ a text-based user interface requires the user to press a function key corresponding to the portion of the expression they would like to edit, and then retype the expression. Another solution simplifies user entry, but it does so by prohibiting the use of all logical operators except AND, which is hard-coded as part of each expression. Yet another one of these existing solutions only accepts certain symbols and keywords, requiring the user to memorize or otherwise maintain a list of the valid input.

Some existing GUI solutions allow the user to add logical operators and parentheses through a series of button clicks. However, these solutions merely replace typing with button clicks, which is hardly more efficient. All of these systems display complex expressions as nested parenthetical statements, and none attempt to make the expressions easier to read.

### BRIEF DESCRIPTION OF THE DRAWINGS

FIG. 1 is a block diagram of a general purpose data network.

FIG. 2 is a schematic diagram of an embodiment of a network computer.

FIG. 3 is a schematic diagram of several system components located in a healthcare facility.

FIG. 4 is an exemplary block diagram illustrating an overview of some components used in a rules-based CDS system.

FIGS. 5A and 5B are flowchart representations of some of the steps used in creating rules with an exemplary rules wizard.

FIG. 6 is an embodiment of a potential user interface to visually create a rule expression.

FIG. 7 is a flowchart representing the functionality of an exemplary AND button.

FIG. 8 is a flowchart representing the functionality of an exemplary OR button.

FIG. 9 is a flowchart representing the functionality of an exemplary NOT button.

FIG. 10 is a flowchart representing the functionality of an exemplary Left Movement button.

FIG. 11 is a flowchart representing the functionality of an exemplary Right Movement button.

FIG. 12 is a flowchart representing the functionality of an exemplary Up Movement button.

FIG. 13 is a flowchart representing the functionality of an exemplary Down Movement button.

FIG. 14 is a flowchart representation of some of the steps used in translating a rule expression from a visual display into an internal format.

### DETAILED DESCRIPTION OF THE PREFERRED EMBODIMENTS

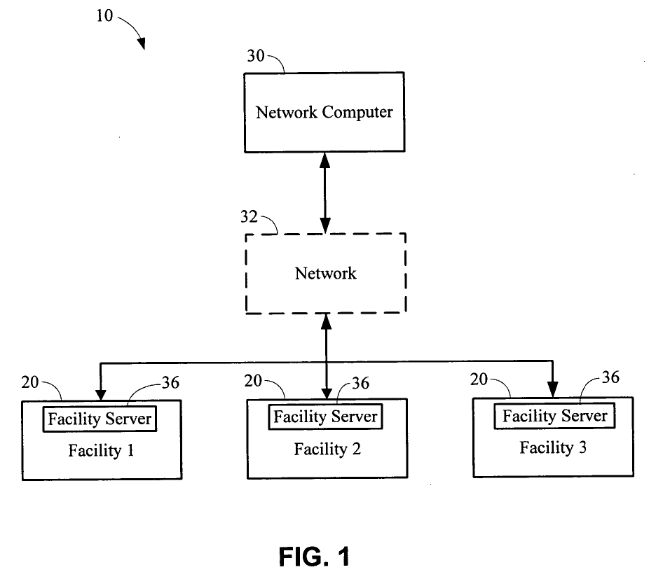

FIG. 1 illustrates an embodiment of an enterprise-wide data network 10 including a first group of healthcare facilities 20 operatively coupled to a network computer (i.e. machine) 30 via a network 32. The plurality of healthcare facilities 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download data relating to a healthcare facility's medical records. For example, the network computer 30 may periodically receive data from each of the healthcare facilities 20 indicative of information pertaining to a patient's medical record, billing information, employee data, etc. The healthcare facilities 20 may include one or more facility servers 36 that may be utilized to store information for a plurality of patients/employees/accounts/etc. associated with each facility.

Although the enterprise-wide data network 10 is shown to include one network computer 30 and three healthcare facilities 20, it should be understood that different numbers of computers and healthcare facilities may be utilized. For example, the network 32 may include a plurality of network computers 30 and dozens of healthcare facilities 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating healthcare data.

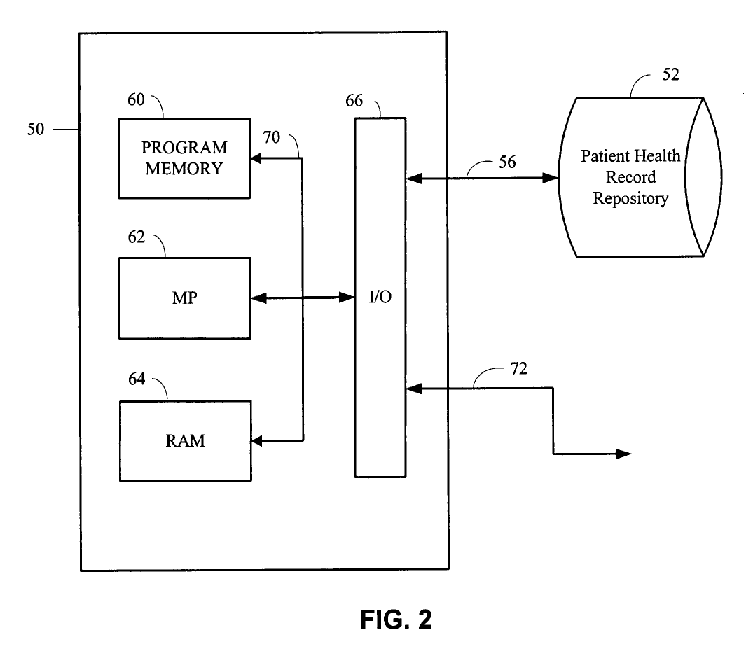

FIG. 2 is a schematic diagram of one possible embodiment of the network computer 30 shown in FIG. 1. The network computer 30 may have a controller 50 that is operatively connected to a patient health record repository 52 via a link 56. It should be noted that, while not shown, additional databases may be linked to the controller 50 in a known manner.

The controller 50 may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. The controller 50 may also be operatively connected to the network 32 via a link 72.

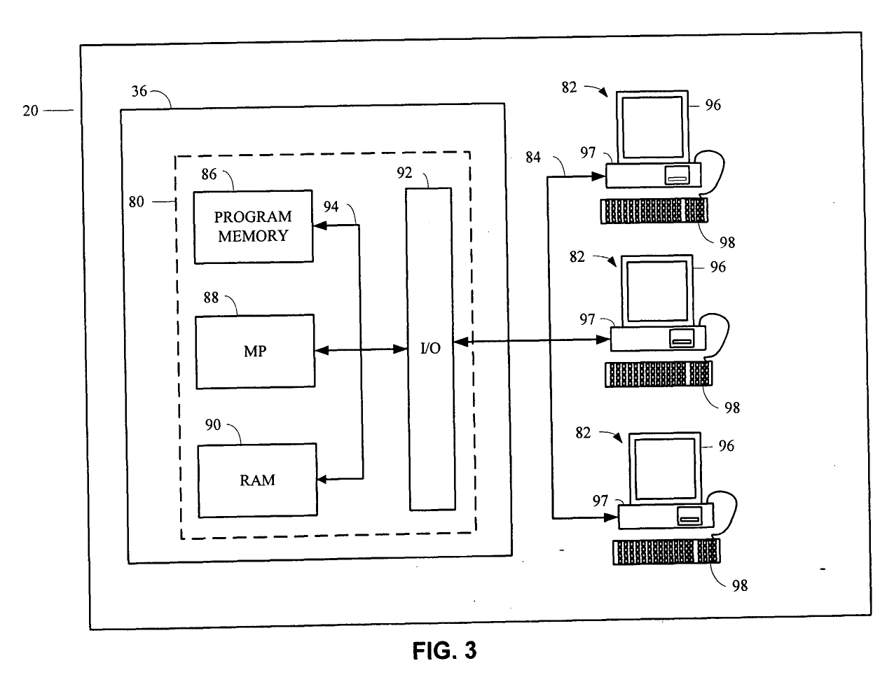

FIG. 3 is a schematic diagram of one possible embodiment of several components located in one or more of the healthcare facilities 20 from FIG. 1. Although the following description addresses the design of the healthcare facilities 20, it should be understood that the design of one or more of the healthcare facilities 20 may be different than the design of other healthcare facilities 20. Also, each healthcare facility 20 may have various different structures and methods of operation. It should also be understood that the embodiment shown in FIG. 3 illustrates some of the components and data connections present in a healthcare facility; however, it does not illustrate all of the data connections present in a typical healthcare facility. For exemplary purposes, one design of a healthcare facility is described below, but it should be understood that numerous other designs may be utilized.

The healthcare facilities 20 may have a facility server 36, which includes a controller 80, wherein the facility server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 1 via the network 32.

Similar to the controller 50 from FIG. 2, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple program memories 86. Although the I/O circuit 92 is shown as a single block, the I/O circuit 92 may include a number of different types of I/O circuits. The RAM(s) 90 and program memories 86 may also be implemented as semiconductor memories, magnetically readable memories, and/or optically readable memories, for example. All of these memories or data repositories may be referred to as machine-accessible mediums.

For the purpose of this description and as briefly discussed above, a machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); etc.

The client device terminals 82 may include a display 96, a controller 97, a keyboard 98 as well as a variety of other input/output devices (not shown) such as a printer, mouse, touch screen, track pad, track ball, isopoint, voice recognition system, etc. Each client device terminal 82 may be signed onto and occupied by a healthcare employee to assist them in performing their duties. Healthcare employees may sign onto a client device terminal 82 using any generically available technique, such as entering a user name and password. If a healthcare employee is required to sign onto a client device terminal 82, this information may be passed via the link 84 to the facility server 36, so that the controller 80 will be able to identify which healthcare employees are signed onto the system and which client device terminals 82 the employees are signed onto. This may be useful in monitoring the healthcare employees' productivity.

Typically, facility servers 36 store a plurality of files, programs, and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

### Overall Operation of the System

One manner in which an exemplary system may operate is described below in connection with a number of flow charts which represent a number of portions or routines of one or more computer programs. These computer program portions may be stored in one or more of the memories in the controllers 50 and 80, and may be written at any high level language such as C, C++, or the like, or any low-level, assembly or machine language. By storing the computer program portions therein, various portions of the memories are physically and/or structurally configured in accordance with the computer program instructions.

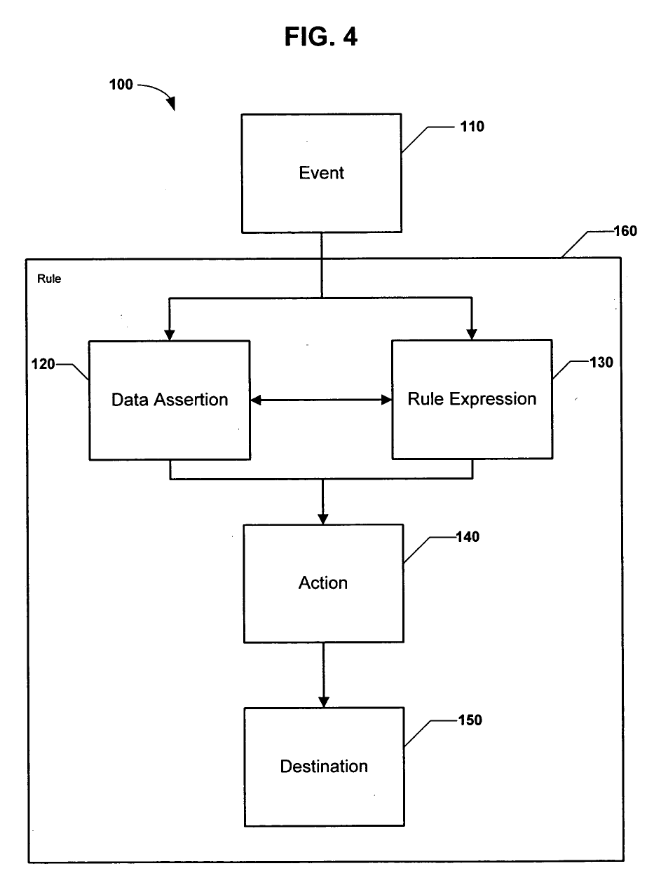

FIG. 4 is an exemplary block diagram illustrating an overview of some components used in a rules-based CDS system 100. Generally, the system 100 allows a complex Boolean expression to be visually represented in such a way that evaluative order and parenthetical nesting are implicitly conveyed to a user. As shown in FIG. 4, an Event 110 may be one of the components in the system 100 that represents a point in the workflow at which the system 100 would examine the state of a patient's record and evaluate one or more rules. Another component may be a Data Assertion component 120. The Data Assertion component 120 is a condition that, when evaluated, may be either true or false. Those of ordinary skill in the art will recognize that, in the clinical setting, decision support is based on performing work when certain conditions exist. Therefore, the system 100 may monitor whether defined data assertions are present while doing its work. In such a system, a data assertion would be the lowest level that is tested. For example, the system could evaluate a single data assertion, such as “Medication Demerol 100 mg Tablets,” to determine whether the patient is taking that medication. Or, the system could evaluate a range assertion, such as “Age>40 AND age<60” to determine whether the patient's age falls within 40 to 60 years.

The embodiment of FIG. 4 includes four categories of data assertions. A first category is Single, which describes a single element that may or may not be present. Examples are medication, diagnosis, and procedure. A second category is Range, which describes values that may or may not be within a given range. An example is a patient's age. A third category is List, which describes a value that may or may not match one of a specified list of values. An example of a List is a patient's sex. A fourth category is Programming Code, which executes a particular programming code that would evaluate to either true or false.

Another component of the rules-based CDS system 100 may be a Rule Expression 130. The rule expression 130 is a Boolean expression that includes data assertions combined with Boolean logical operators to any level of parenthetical abstraction. Like data assertions, rule expressions, when evaluated, are either true or false. For example, a simple rule expression could be “Medication Demerol 100 mg Tablets AND Diagnosis Congestive Heart Failure,” which would evaluate to true only if the patient was taking Demerol 100 mg and was also diagnosed with congestive heart failure. Complex rule expressions with multiple data assertions and logical operators would be allowed. In the rules-based CDS system 100, the Boolean logical operators permitted in the rule expression 130 may be AND, OR and NOT.

The rules-based CDS system 100 also includes an Action component 140. The Action component 140 is the work that the rules-based CDS system 100 would perform when an event occurs. Some examples of actions could be: messages presented to a user, proactive health maintenance or guidance topics added to a patient's record, medication or procedure alternatives suggested, and programming code executed.

In the rules-based CDS system 100, the Actions 140 are grouped into action sets, which are collections of actions that could be associated with a rule. When a rule evaluates as true, any action set subscribing to that rule could be activated and any associated actions performed.

Another component included in the rules-based CDS system 100 is a Destination component 150. The Destination component 150 is a set of filters describing the user or users for which the action applies. For example, an action that displays a message may have a destination of “Specialty Cardiology.” In this case, a user would be shown the message only if the system identifies the user as a Cardiology specialist. In the Destination component 150, destinations may tailor actions sets for groups of users. For example, nurses could be shown a different set of messages than physicians. Furthermore, each action might have a destination, but actions also could be stored with no destination, in which case they would apply for all users.

When combined, the Data Assertions 120, the Rule Expressions 130, the Actions 140, and the Destinations 150 constitute a rule 160. In the rules-based CDS system 100, a rule describes the conditions under which the system 100 is to perform a defined set of actions. From a larger perspective, the rules-based CDS system 100 allows a user to construct one or more complex CDS rules by visually combining data assertions and logical operators into well-formed Boolean expressions that contain nested parenthetical statements, thereby making it possible for clinical users to quickly and accurately write their own objective and subjective CDS rules.

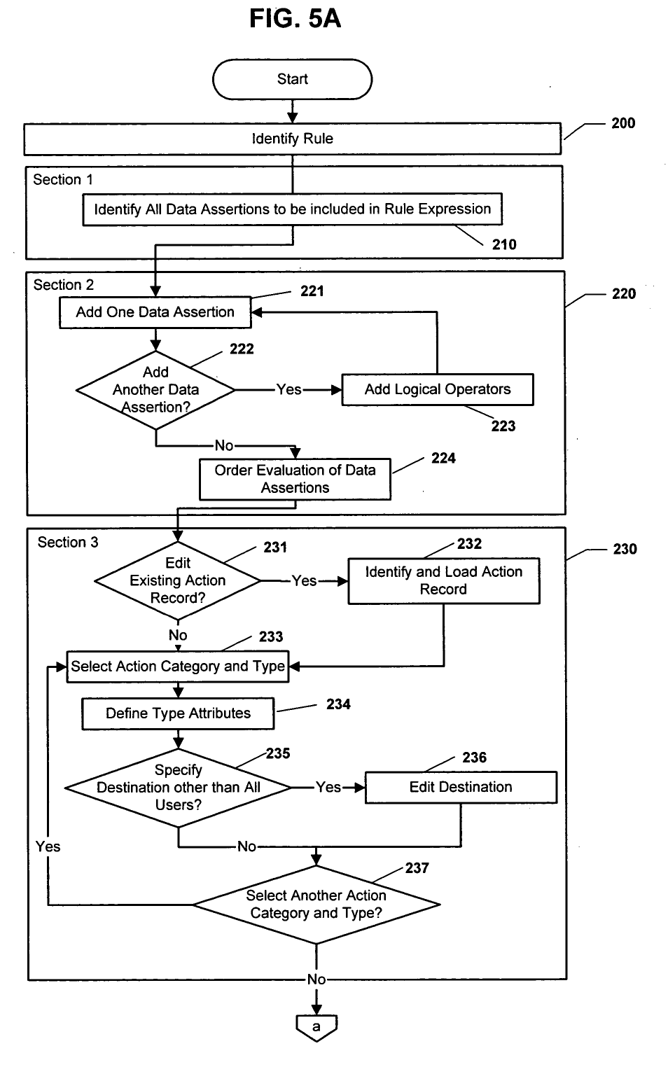

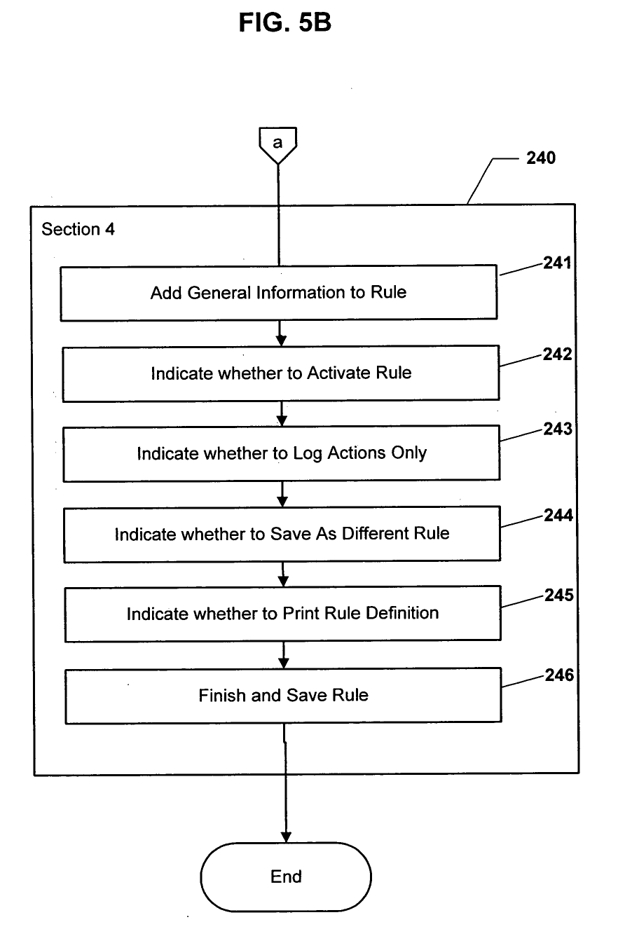

FIGS. 5A and 5B are flowchart representations of some of the steps used in creating rules with an exemplary rules wizard. In the embodiment of FIGS. 5A and 5B, an EMR system may employ a rules wizard, or an interactive utility that would guide a clinician or an end-user through each step of creating a CDS rule. When the end-user would activate the rules wizard, he or she could be prompted to identify the rule by entering a rule name and a general description (block 200).

As shown at a block 210, the end-user could select all of the data assertions to be added to the rule expression. As part of Section 2 (220) of the wizard, the end-user may select at least one of the data assertions and add it to the rule expression (block 221). If it is determined that the end-user would like to add another data assertion (block 222), the end-user would add the appropriate logical operators to the rule expression (block 223) and then select and add another data assertion (block 221). The end-user would repeat this process until all data assertions and logical operators are added to the rule expression. To complete the rule expression, the end-user would determine which of the data assertions should be evaluated first, second, third (and so forth) (block 224).

As part of Section 3 (230) of the wizard, the end-user may define what actions the system should take when the rule expression evaluates to true. To begin, the end-user might elect to edit an existing action (block 231). If so, the end-user would identify and load the information about that action (block 232). For each action, the end-user would select an action category and type (block 233) and then define any attributes for that type (block 234), such as the text that would be displayed for a pop-up message. In addition, for each action type, instead of directing the action to All Users, the end-user might elect to limit the group of users to whom the action is directed (block 235). If so, the end-user would edit the destination (block 236). The end-user would repeat this process until all actions are defined for the rule (block 237).

As part of the final section of the wizard, Section 4 (240) of FIG. 5B, the user would define general information (block 241) about the rule, such as the rule's purpose and explanation, indicate whether the rule should be made active (block 242), and indicate whether the rule should log (instead of perform) associated actions (block 243). The end-user could also save the rule as a different rule (block 244) and print the rule's complete definition (block 245). After performing any of these actions as needed, the end-user would finish the rule creation process, which may automatically save the rule (block 246) and end the rules wizard.

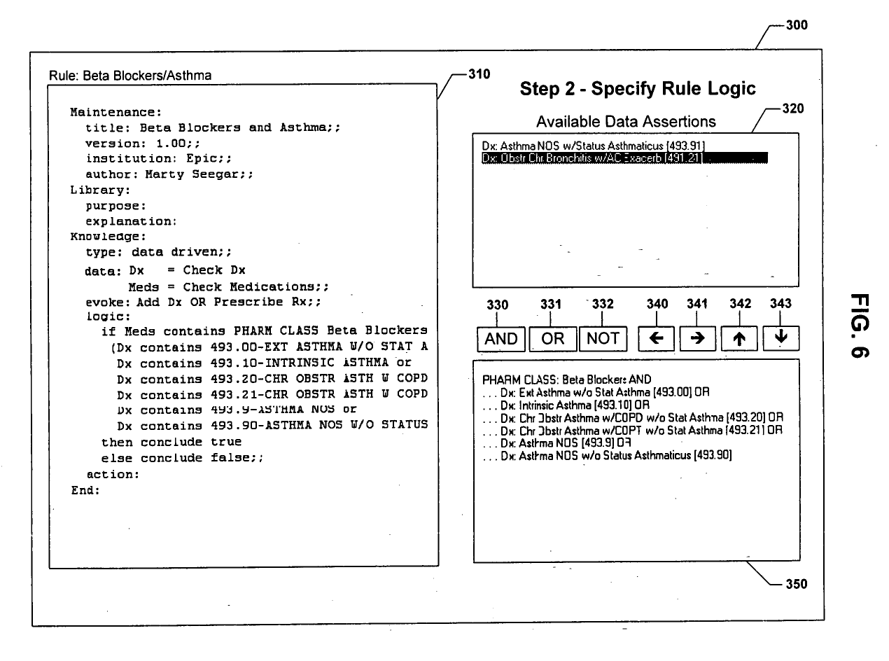

FIG. 6 is an embodiment of a potential user interface to visually create a rule expression. The user interface includes a display 300 having the following visual elements: a complete textual description 310 of the rule, a list of data assertions 320, three buttons corresponding to the Boolean logical operators AND 330, OR 331 and NOT 332, four buttons corresponding to the movement directions up 340, down 342, left 343 and right 343, and a grid 350 representing a hierarchal display of the rule expression.

These visual elements allow the user to combine data assertions and logical operators into what may eventually become a well-formed Boolean expression. Users of the apparatus would understand that list position and indentation represent different levels of parenthetical abstraction in the rule expression. In particular, users would understand the following: 1) for a rule expression with no rows indented, the apparatus may evaluate the data assertions row by row, from top to bottom, and 2) for a rule expression with one or more rows indented, the system may evaluate the data assertions for the rows indented furthest from the left first, working outward through lesser indented rows, but always evaluating multiple rows indented to the same level from top to bottom. The use of indentations to represent parenthetical nesting ensures that closing parentheses are correctly supplied, which has been a notoriously tricky task for users when working with a system that allows them to create complex expressions with deep parenthetical nesting.

To build the rule expression, the user would add to the rule expression grid 350 any and all data assertions available from the data assertion list 320. The data assertion list 320 may include several rows, one for each data assertion. Only one row could be selected and highlighted at any given time. Double-clicking a row of the data assertion list would remove the data assertion from the list and move it to the next available row in the rule expression grid 350. Each data assertion could only be added to the grid 350 once.

In addition, the user may click the AND 330, OR 331 and NOT 332 buttons to assign logical operators to each selected row in the rule expression grid 350. Each row in the grid 350 could have either an AND or OR operator listed. Since these operators in FIG. 6 are mutually exclusive, clicking the AND button 330 when the selected rule expression row already contained an OR operator would cause the OR operator to be removed and replaced with an AND operator (and vice versa). Clicking the NOT button 332 would add or remove the NOT operator. The AND and OR operators may always be displayed after the data assertion in the selected row of the grid. The NOT operator may be displayed at the end of the row after the AND or OR.

It should be noted that the user may determine which of the data assertions should be evaluated first, second, third (and so forth). This would be accomplished by: 1) allowing the user to order the rows top to bottom, and 2) allowing the user to add indentation to a row, thereby specifying a deeper parenthetical nesting. As those of ordinary skill in the art understand, when evaluating a Boolean expression with multiple levels of nesting, precedence is granted to the most deeply nested expressions.

Users would click the four movement buttons (340) (341) (342) (343), which would be represented with arrows pointing left, right, up and down right, to manipulate the data assertions in the grid 350. When clicked, the up 342 and down 343 buttons would move the selected row, including its associated Boolean operators, up or down within the grid 350. The left 340 and right 341 buttons, when clicked, would extend or indent the information in the selected row. In this fashion, by visually showing the rule expression as a hierarchal display of data assertions and logical operators, the rule expression would be displayed without a series of nested parentheses, making the expression easier to read and understand. Furthermore, the movement buttons allow the structure of a hierarchal list to be manipulated in order to construct the evaluative order and parenthetical nesting of a complex Boolean expression.

Those of ordinary skill in the art will recognize that the functionality of the invention may be represented in other graphic layouts than those depicted in this display 300. It is to be understood that the layout is presented for illustration purposes and is not meant to limit the invention.

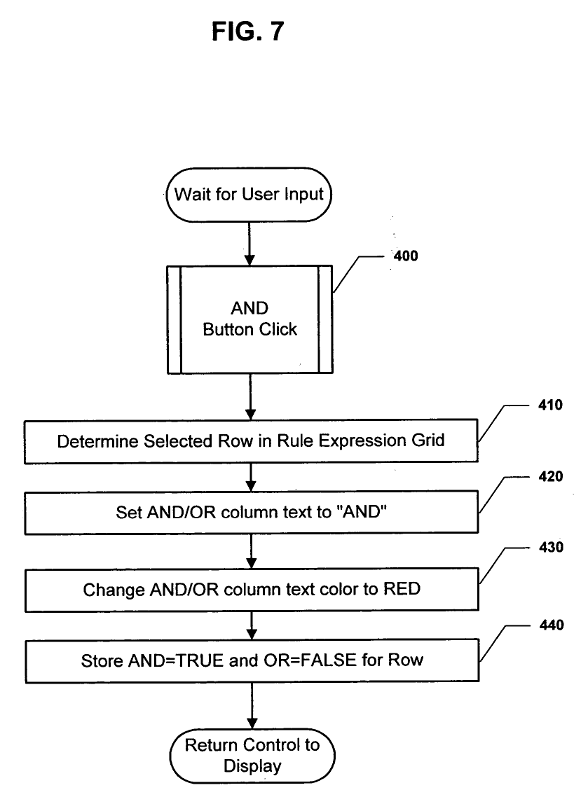

FIG. 7 is a flowchart representing the functionality of an exemplary AND button. In the embodiment of FIG. 7, when the user clicks the AND button (block 400), the system performs a series of actions that update the visual display 300 of the rule expression grid 350 and temporarily store information in memory. First, the system determines which row of the grid 350 was selected (block 410) at the time of the AND button click. Next, it would update the visual display 300 by adding the word “AND” to the correct column of the selected row (block 420) and change the color of that column's text to red (block 430). Finally, before returning control to the display, the system would store information about the selected row into a structured array (block 440). Specifically, it would set the variable's AND member equal to TRUE and the OR member equal to FALSE for the subscript equal to that of the selected row number.

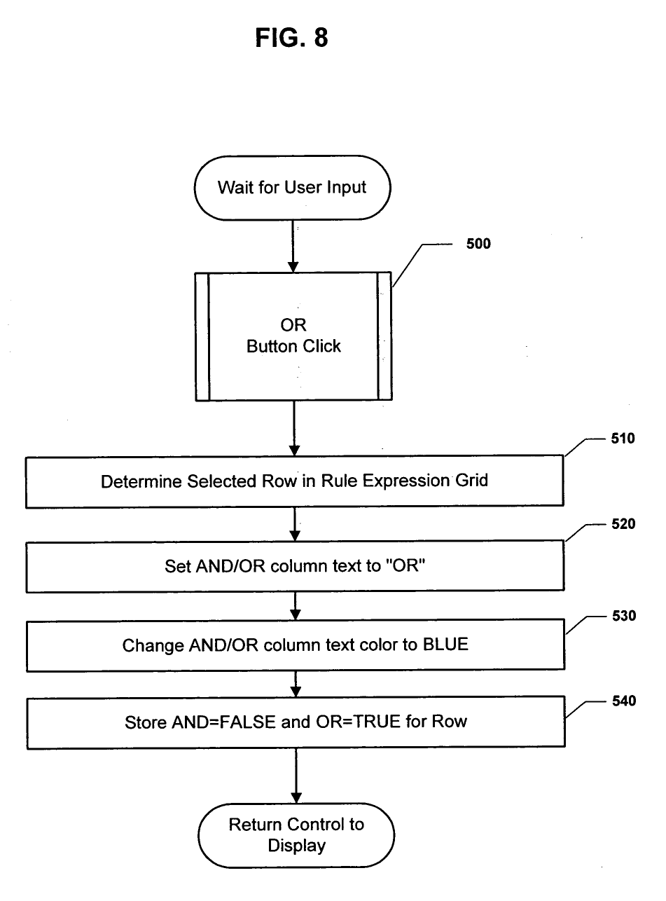

FIG. 8 is a flowchart representing the functionality of an exemplary OR button. In the embodiment of FIG. 8, when the user would click the OR button (block 500), the system would perform a series of actions that update the visual display 300 of the rule expression grid 350 and temporarily store information in memory. First, the system would determine which row of the grid was selected (block 510) at the time of the OR button click. Next, it would update the visual display 300 by adding the word “OR” to the correct column of the selected row (block 520) and change the color of that column's text to blue (block 530). Finally, before returning control to the display, the apparatus would store information about the selected row into a structured array (block 540). Specifically, it would set the AND member equal to FALSE and the OR member equal to TRUE for the subscript equal to that of the selected row number.

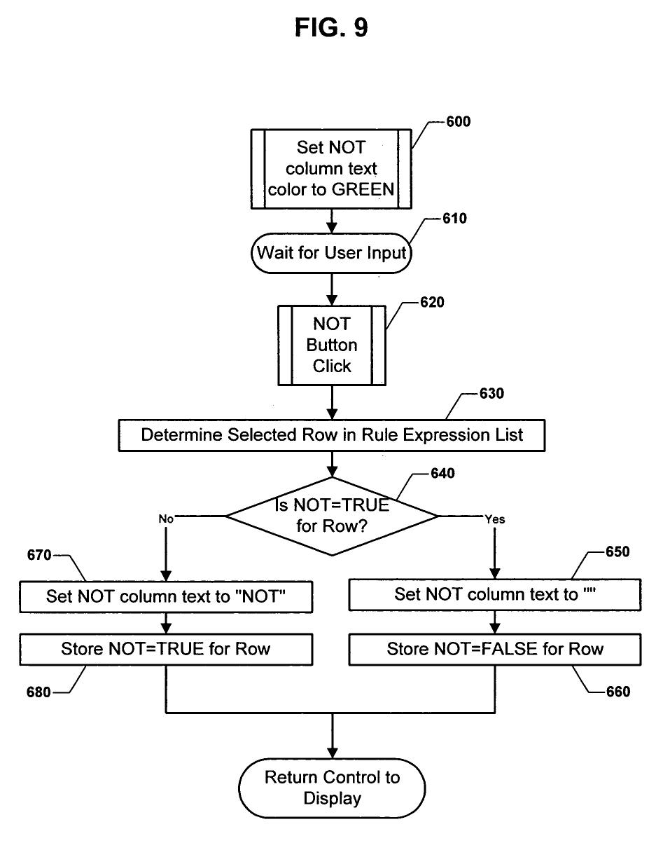

FIG. 9 is a flowchart representing the functionality of an exemplary NOT button. In the embodiment of FIG. 9, when the display 300 would first show the rule expression grid 350, the color of the text in the column that displays the NOT logical operator would be set to green (block 600). The system would then wait for user input (block 610). When the user would click the NOT button (block 620), the system would determine which row of the rule expression grid was selected (block 630).

Next, it would evaluate whether the value stored in the structured array's NOT member equals TRUE for the subscript equal to that of the selected row number (doing so would indicate whether the word “NOT” is already displayed in the selected row) (block 640). If indeed the NOT member equals TRUE, then the apparatus would update the visual display 300 of the grid 350 by removing the word “NOT” from the correct column of the selected row (block 650). It would also update the structured array, setting the NOT member equal to FALSE for the subscript equal to that of the selected row number (block 660).

Conversely, if the NOT member equals FALSE, then the system would update the visual display 300 of the grid 350 by adding the word “NOT” to the correct column of the selected row (block 670). It would also update the structured array, setting the NOT member equal to TRUE for the subscript equal to that of the selected row number (block 680).

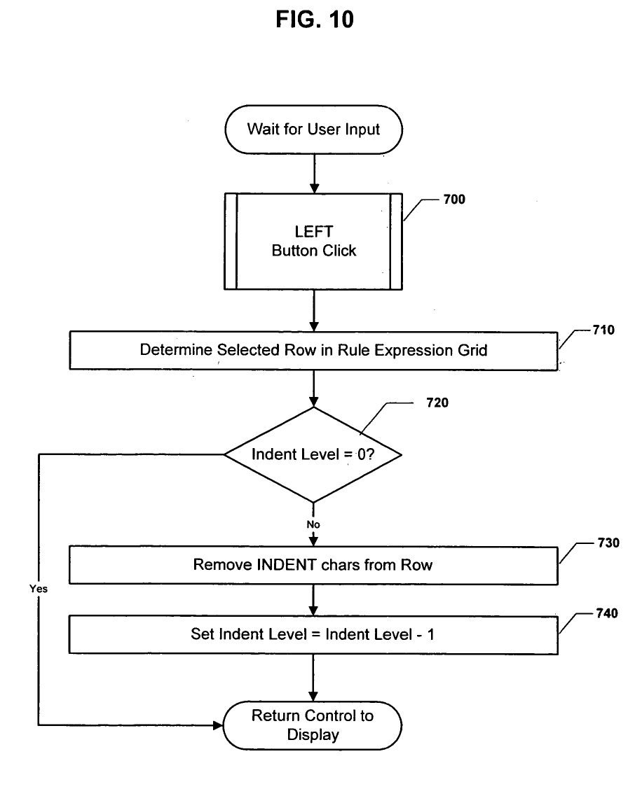

FIG. 10 is a flowchart representing the functionality of an exemplary Left Movement button. In the embodiment of FIG. 10, when the user clicks the LEFT button (block 700), the system performs a series of actions that update the visual display of the rule expression grid 350 and temporarily stores information in memory. First, the system would determine which row of the grid 350 was selected (block 710) at the time of the LEFT button click. The system may then evaluate whether the selected row was indented (block 720). If the row were indented (and therefore could be moved left), the system would update the visual display by removing special indent characters from the row's text (block 730). Finally, before returning control to the display, the apparatus would store information about the selected row into a structured array (block 740). Specifically, it would decrement by one the INDENT LEVEL member for the subscript equal to that of the selected row number.

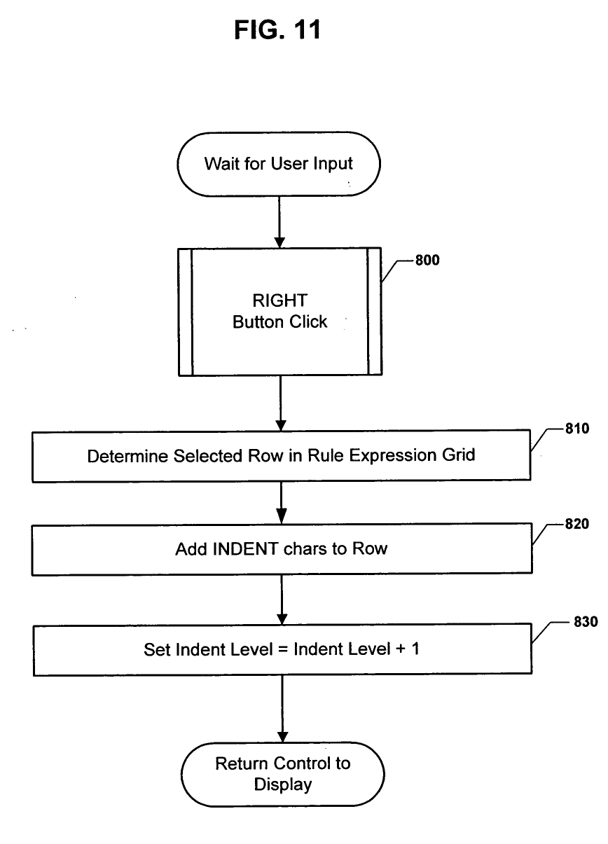

FIG. 11 is a flowchart representing the functionality of an exemplary RIGHT Movement button. In the embodiment of FIG. 11, when the user would click the RIGHT button (block 800), the system would perform a series of actions that update the visual display of the rule expression grid 350 and temporarily store information in memory. The system may determine which row of the grid 350 was selected (block 810) at the time of the RIGHT button click. The system may then update the visual display by adding special indent characters to the row's text (block 820). Finally, before returning control to the display, the system would store information about the selected row into a structured array (block 830). Specifically, it would increment by one the INDENT LEVEL member for the subscript equal to that of the selected row number.

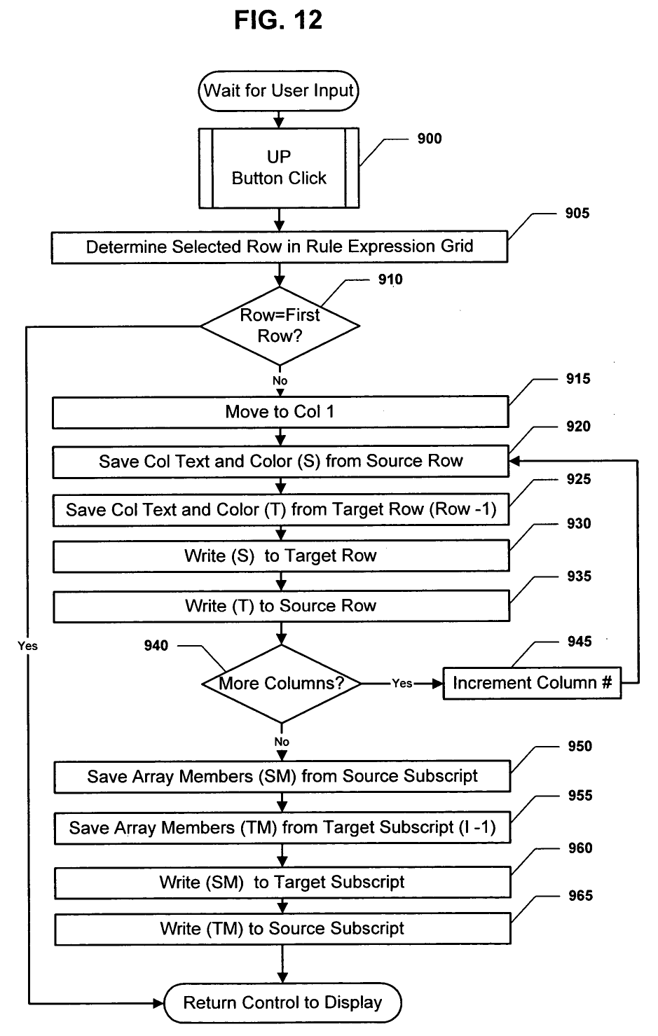

FIG. 12 is a flowchart representing the functionality of an exemplary UP Movement button. In the embodiment of FIG. 12, when the user would click the UP button (block 900), the system may perform a series of actions that update the visual display of the rule expression grid 350 and temporarily store information in memory. First, the system may determine which row of the grid 350 was selected (block 905) at the time of the UP button click. Next, the system would evaluate whether the selected row was the first row (block 910). If the row was not the first row (and therefore could be moved up), the system would programmatically select the first column within the selected row (block 915). Then the system would temporarily save that column's text value and text color, first for the selected (or source) row (block 920), and then for the target row above it (Row−1) (block 925). After temporarily saving the column information, the system would swap the information between rows by writing the previously saved information from the source row to the target row (block 930) and by writing the previously saved information from the target row to the source row (block 935).

Next, the system would evaluate whether there were more columns in the source row (block 940). If so, it would increment the column number (block 945) and repeat the swap of column information (blocks 920-935) until there were no more columns.

Next, similar to the swap of column information between rows, the system would swap information in the structured array. Specifically, the system would temporarily save the member values, first for the subscript equal to the source row (block 950), and then for the subscript equal to the target row (I−1) (block 955). Finally, before returning control to the display, the system would swap the information between the subscripts by writing the previously saved information from the source subscript to the target subscript (block 960) and by writing the previously saved information from the target subscript to the source subscript (block 965).

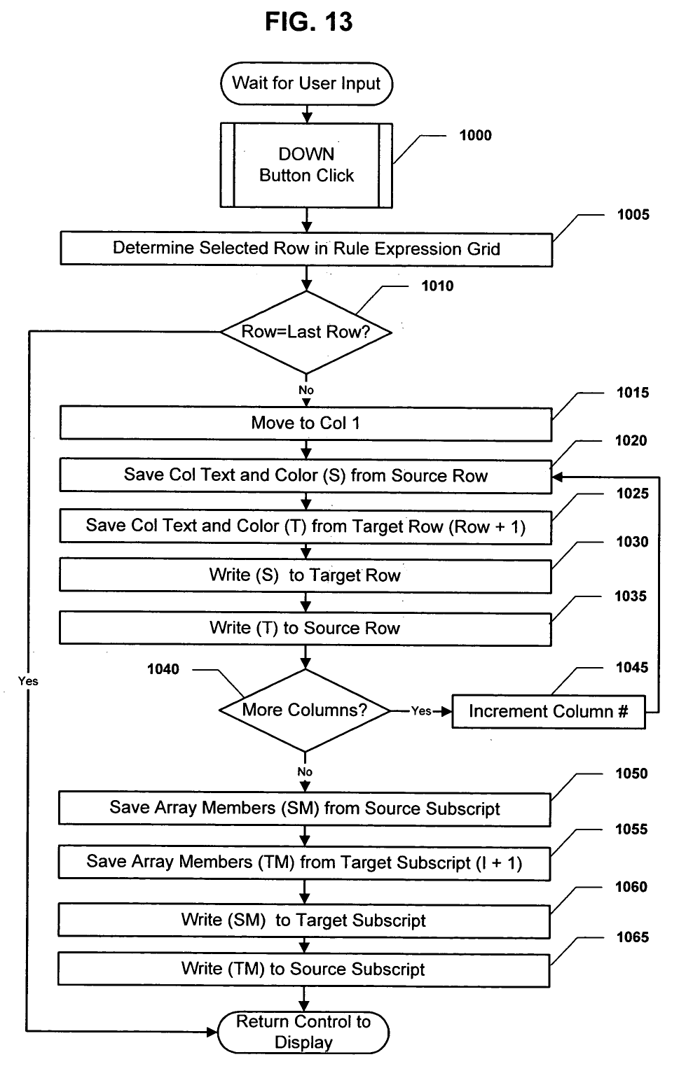

FIG. 13 is a flowchart representing the functionality of an exemplary DOWN Movement button. In the embodiment of FIG. 13, when the user would click the DOWN button (block 1000), the system would perform a series of actions that update the visual display of the rule expression grid 350 and temporarily store information in memory. First, the system would determine which row of the grid was selected (block 1005) at the time of the DOWN button click. Next, the system would evaluate whether the selected row was the last row (block 1010). If the row were not the last row (and therefore could be moved down), the system would programmatically select the first column within the selected row (block 1015). Then the system would temporarily save that column's text value and text color, first for the selected (or source) row (block 1020), and then for the target row below it (Row+1) (block 1025). After temporarily saving the column information, the system would swap the information between rows by writing the previously saved information from the source row to the target row (block 1030) and by writing the previously saved information from the target row to the source row (block 1035).

Next, the system would evaluate whether there were more columns in the source row (block 1040). If so, it would increment the column number (block 1045) and repeat the swap of column information (blocks 1020-1035) until there were no more columns.

Next, similar to the swap of column information between rows, the system would swap information in the structured array. Specifically, the system would temporarily save the member values, first for the subscript equal to the source row (block 1050), and then for the subscript equal to the target row (I+1) (block 1055). Finally, before returning control to the display, the system would swap the information between the subscripts by writing the previously saved information from the source subscript to the target subscript (block 1060) and by writing the previously saved information from the target subscript to the source subscript (block 1065).

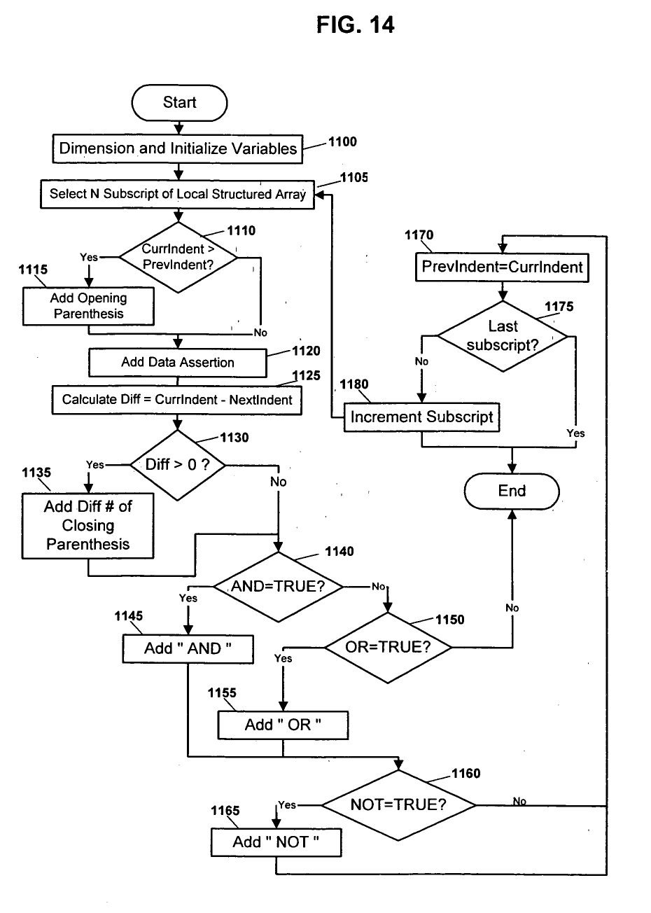

FIG. 14 is a flowchart representation of some of the steps used in translating a rule expression from a visual display into an internal format that could be evaluated using programming code. In other words, the visual display of the Boolean expression is translated into a well-formed expression for evaluation by programming code. For example, a rule expression in the grid 350 might be displayed as follows:

A OR NOT

. . . B AND

. . . C OR

. . . D AND

. . . E AND

. . . F

The system may translate the above example into the following Boolean expression:

A OR NOT (B AND C OR (D AND E) AND F)

As this example illustrates, rows in grid that are indented to a greater extent than the rows preceding them represent a deeper level of parenthetical nesting. Conversely, a row that is indented to a lesser extent than the row preceding it represents a lesser level of parenthetical nesting.

To create the internal format for the rule expression, the translator may loop through the subscripts of the local structured array (which would temporarily store pertinent information about the data assertions and logical operators displayed in the grid) and build up a string variable through concatenation.

The translation may be performed using the following exemplary algorithm, which would ensure that the opening and closing parentheses are added to correct portion of the concatenated string:

Do not precede the first data assertion with an opening parenthesis.

If a row Y is indented to a greater extent than row X preceding it, add an opening parenthesis before the data assertion contained in row Y.

If a row Y is indented to a greater extent than row Z following it, add N number of closing parentheses after the data assertion contained in row Y, where N equals the difference between the level of indentions between row Y and row Z.

Discard all operators following the last data assertion.

To begin, the translator may first dimension and initialize a series of local variables (block 1100). It may then select the N subscript of the local structured array (block 1105) and compare the current subscript's indentation level to the previous subscript's indentation level (block 1110), which would be temporarily stored in a local variable. If the current indentation level was greater than the previous, the translator would add an opening parenthesis to the concatenated expression string (block 1115). Then, the translator would add the data assertion to the expression string (block 1120).

Next, the translator may calculate the numerical difference, Diff, between the current subscript's indentation level and the next subscript's indentation level (block 1125). If the difference was greater than zero (block 1130), the translator adds Diff number of closing parenthesis to the expression string (block 1135).

Next, the translator may add the logical operators. If the current subscript's AND member was TRUE (block 1140), the translator may add the operator “AND” to the expression string (block 1145). However, if the OR member was TRUE (block 1150), the translator would add the operator “OR” to the expression string (block 1155). In addition, if the NOT member was TRUE (block 1160), the translator would add the operator “NOT” to the expression string (block 1165).

Following this, the translator would save the current indentation level as the new previous indentation level (block 1170), and then evaluate whether this was the last subscript in the array (block 1175). If it is determined that this was not the last subscript, the translator would increment the subscript value by one (block 1180) and repeat the process until all subscripts were exhausted. If this was the last subscript, the translation would end and the expression would be correctly formatted for internal processing.

Although the technique for constructing complex Boolean expressions described herein is preferably implemented in software, it may be implemented in hardware, firmware, etc., and may be implemented by any other processor associated with the organization. Thus, the routines described herein may be implemented in a standard multi-purpose CPU or on specifically designed hardware or firmware as desired. When implemented in software, the software routine may be stored in any computer readable memory such as on a magnetic disk, a laser disk, in a RAM or ROM of a computer or processor, or other machine accessible storage medium, etc. Likewise, this software may be delivered to a user or a process control system via any known or desired delivery method including, for example, on a computer readable disk or other transportable computer storage mechanism or over a communication channel such as a telephone line, the internet, etc. (which are viewed as being the same as or interchangeable with providing such software via a transportable storage medium).

The invention has been described in terms of several preferred embodiments. It will be appreciated that the invention may otherwise be embodied without departing from the fair scope of the invention defined by the following claims.

1. A method of constructing a Boolean expression in a clinical setting, comprising:
identifying at least a first and a second data assertion to add to the Boolean expression;
adding at least one Boolean logical operator to the Boolean expression;
determining an order of evaluation for the first and second data assertions; and
visually depicting the first and second data assertions and the Boolean logical operator in a hierarchal display.

2. The method of claim 1, further comprising determining an action to be taken when the Boolean expression evaluates to true.

3. The method of claim 2, further comprising limiting the group of users for which the action applies.

4. The method of claim 1, further comprising allowing a user to modify the order of the first and the second data assertion with the use of an up button or a down button.

5. The method of claim 1, further comprising evaluating first either the first or the second data assertion that is displayed highest in the hierarchal display.

6. The method of claim 1, further comprising linking the Boolean expression to a patient's electronic medical record.

7. The method of claim 1, further comprising evaluating first either the first or the second data assertion that is indented furthest from the left in the hierarchal display.

8. The method of claim 1, wherein the step of selecting the first data assertion comprises selecting a condition that, when evaluated, is either true or false.

9. The method of claim 1, wherein the step of selecting the first data assertion comprises selecting one of: a single element, a range, a list, or a programming code.

10. The method of claim 1, wherein adding the at least one Boolean logical operator comprises adding one of the following Boolean logical operators: AND, OR, or NOT.

11. A method of constructing a Boolean expression to provide clinical decision support, comprising:
identifying a set of data assertions to be added to the Boolean expression;
selecting a plurality of data assertions from the set of data assertions to add to the Boolean expression;
adding a plurality of Boolean logical operators to the Boolean expression;
determining an order of evaluation for the plurality of data assertions;
visually depicting the plurality of data assertions and the plurality of Boolean logical operators in a hierarchal display of the Boolean expression;
determining an action to be taken when the Boolean expression evaluates to true; and
limiting the group of users for which the action applies.

12. The method of claim 11, further comprising allowing a user to modify the order of the plurality of data assertions with the use of one of an up button or a down button.

13. The method of claim 11, further comprising evaluating the plurality of data assertions row by row, from top to bottom in the hierarchal display, when none of the data assertions are indented.

14. The method of claim 11, further comprising linking the Boolean expression to a patient's electronic medical record.

15. The method of claim 11, further comprising allowing a user to indent one or more of the data expressions from the plurality of data expressions to represent different levels of parenthetical abstraction in the Boolean expression.

16. The method of claim 11, further comprising evaluating the plurality of data assertions indented furthest from the left first, working outward through lesser indented data assertions, and evaluating multiple data assertions indented to the same level from top to bottom in the hierarchal display.

17. The method of claim 11, wherein the step of selecting the plurality of data assertions comprises selecting conditions that, when evaluated, are either true or false.

18. A method of constructing a clinical decision support rule expression comprising:
identifying a set of data assertions to be added to the rule expression;
selecting a plurality of data assertions from the set of data assertions to add to a rule expression grid, wherein the rule expression grid includes a plurality of rows with one of the plurality of data assertions displayed in each row or the plurality of rows;
adding one or more Boolean logical operators to the rule expression, wherein the one or more Boolean logical operators are added to the rows of the rule expression grid;
determining an order of evaluation for the plurality of data assertions; and
visually depicting the rule expression grid as a hierarchal display of the rule expression.

19. The method of claim 18, further comprising determining an action to be taken when the rule expression evaluates to true.

20. The method of claim 19, further comprising limiting the group of users for which the action applies.

21. The method of claim 18, further comprising evaluating the plurality of data assertions row by row, from top to bottom in the hierarchal display, when none of the data assertions are indented.

22. The method of claim 18, further comprising allowing a user to modify the order of the plurality of data assertions in the rule expression grid, with the use of an up button or a down button.

23. The method of claim 18, further comprising allowing a user to indent one or more of the data expressions from the plurality of data expressions to represent different levels of parenthetical abstraction in the rule expression.

24. The method of claim 18, further comprising evaluating the plurality of data assertions for the rows indented furthest from the left first, working outward through lesser indented rows, and evaluating multiple rows indented to the same level from top to bottom in the hierarchal display.

25. A system for constructing a Boolean expression in a clinical setting, comprising:
means for identifying at least a first and a second data assertion to add to the Boolean expression;
means for adding at least one Boolean logical operator to the Boolean expression;
means for determining an order of evaluation for the first and second data assertions; and
means for visually depicting the first and second data assertions and the Boolean logical operator in a hierarchal display.

26. The system of claim 25, further comprising means for determining an action to be taken when the Boolean expression evaluates to true.

27. The system of claim 26, further comprising means for limiting the group of users for which the action applies.

28. The system of claim 25, further comprising means for allowing a user to modify the order of the first and the second data assertion with the use of one of an up button or a down button.

29. The system of claim 25, further comprising means for evaluating first either the first or the second data assertion that is displayed highest in the hierarchal display.

30. The system of claim 25, further comprising means for allowing a user to modify the order of the first and the second data assertion with the use of one of an up button or a down button.

31. The system of claim 25, further comprising means for evaluating first either the first or the second data assertion that is indented furthest from the left in the hierarchal display.

32. The system of claim 25, wherein the means for adding the at least one Boolean logical operator comprises means for adding one of the following Boolean logical operators: AND, OR, or NOT.

33. An article comprising a machine-accessible medium having stored thereon instructions that, when executed by a machine, cause the machine to:
identify a set of data assertions to be added to a clinical decision support rule expression;
select a plurality of data assertions from the set of data assertions to add to a rule expression grid, wherein the rule expression grid includes a plurality of rows with one of the plurality of data assertions displayed in each row or the plurality of rows;
add one or more Boolean logical operators to the rule expression, wherein the one or more Boolean logical operators are added to the rows of the rule expression grid;
determine an order of evaluation for the plurality of data assertions; and
visually depict the rule expression grid as a hierarchal display of the rule expression.

34. The article of claim 33, having further instructions that, when executed by the machine, cause the machine to determine an action to be taken when the rule expression evaluates to true.

35. The article of claim 33, having further instructions that, when executed by the machine, cause the machine to limit the group of users for which the action applies.

36. The article of claim 33, having further instructions that, when executed by the machine, cause the machine to evaluate the plurality of data assertions row by row, from top to bottom in the hierarchal display, when none of the data assertions are indented.

37. The article of claim 33, having further instructions that, when executed by the machine, cause the machine to allow a user to modify the order of the plurality of data assertions in the rule expression grid.

38. The article of claim 33, having further instructions that, when executed by the machine, cause the machine to allow a user to indent one or more of the data expressions from the plurality of data expressions to represent different levels of parenthetical abstraction in the rule expression.

39. The article of claim 33, having further instructions that, when executed by the machine, cause the machine to evaluate the plurality of data assertions for the rows indented furthest from the left first, working outward through lesser indented rows, and evaluate multiple rows indented to the same level from top to bottom in the hierarchal display.
